(19) United States
(12) Patent Application Publication
(10) Pub. No.: US 2009/0281907 A1
(43) Pub. Date: Nov. 12, 2009

(54) METHOD AND ARRANGEMENT FOR PURCHASING STREAMED MEDIA

(76) Inventor: Robert Skog, Hasselby (SE)

Correspondence Address: ERICSSON INC., 6300 LEGACY DRIVE, M/S EVR 1-C-11, PLANO, TX, 75024, US

(21) Appl. No.: 12/306,851

(22) PCT Filed: Jun. 29, 2006
(86) PCT No.: PCT/SE2006/000800

§ 371 Date: Mar. 27, 2009

(51) Int. Cl. G06Q 30/00; G06Q 50/00; G06F 15/16

(52) U.S. Cl. 705/26; 709/231

(57) ABSTRACT

A method and arrangement for purchasing streamed media as executed in a communication terminal operated by a user when receiving a media stream containing various media objects as data packets from a streaming server. In response to receiving user input for the purchase of a currently played wanted media object, a purchase request is sent to the streaming server. In response to the purchase request, a download enabler is received containing information leading to the wanted media object. The wanted media object is then downloaded based on the received download enabler.

### TECHNICAL FIELD

The present invention relates generally to a method and arrangement for purchasing media received by means of streaming, particularly music. In particular, the present invention can be used when purchasing media being streamed in a live radio broadcast.

### BACKGROUND

Today, services involving the streaming of media such as audio and video are available over the Internet. For example, radio programs can be received at Internet-enabled communication terminals by means of the well-known streaming technique, as an alternative to receiving broadcasted radio signals by means of a radio receiver in the traditional manner. It is now common that radio companies offer so-called “web radio” over the Internet, either as audio files or as live broadcasted streaming in real-time, the latter being mostly used for mobile terminals since downloading audio files requires considerable memory capacity often lacking in such terminals. The following description will relate to the streaming of media in general and to live broadcasted streaming in particular.

These streaming services typically utilise RTP, the Real-Time Transport Protocol according to the standard RFC 3550, for transmission of the media to receiving terminals. RTP provides end-to-end network transport when transmitting real-time data, such as audio and video, to terminals using multicast or unicast network services. RTP does not address resource reservation and does not guarantee quality-of-service for real-time services. The data transport is supported by a control protocol (RTCP) for monitoring data delivery, among other things. RTP and RTCP are designed to be independent of the underlying transport and network layers. Applications typically run RTP on top of UDP (User Datagram Protocol) utilizing its multiplexing and checksum functions. However, RTP may be used with other suitable underlying network or transport protocols as well.

The RTP and RTCP protocols handle payload type identification, sequence numbering, time stamping and delivery monitoring. Hence, each RTP packet in a media stream includes a header containing a sequence number and a time stamp. If the packets do not arrive in sequence, the sequence numbers included in RTP allow the receiver to reconstruct the sender's packet sequence. The timing information of the time stamp and sequence number in the RTP header thus allows receiving terminals to reconstruct the timing produced by the source, in order to contiguously play chunks of audio, e.g., every 20 ms.

If an end-user is listening to a song received by means of streaming audio, he/she may want to purchase that song. In order to do that, there must be some way that the user can identity the song if not recognised anyway. Even if the song is announced vocally in the radio program, the user may not hear it or remember it later. A mechanism has been devised for informing listeners on content being played, otherwise than being announced vocally, which will now be described with reference to FIG. 1.

FIG. 1 illustrates how media being streamed from a live radio broadcast can be identified and purchased according to a conventional procedure. A streaming server 100 receives broadcasted live radio channels from one or more radio stations 102, either in regular radio broadcasts as shown in the figure, or by means of fixed wireline connections. Any of the received live radio channels can then be transmitted upon request to terminals practically in real-time by means of the above-described streaming technique.

In this example, a terminal 104 receives a media stream from the streaming server 100, which is played out in real-time at the terminal 104. Conventionally, certain information regarding the transmitted media is also transmitted in a separate channel simultaneously, often referred to as “metadata”. Such metadata may include information on a particular piece of music being currently played, e.g. the title and artist, and also further information on what will be played next, etc.

This information can then be displayed at the receiving terminal 104 during playback of the piece. Thereby, the user is able to identify the played music piece and purchase it from a content provider 106, e.g. over the Internet or in a music shop or the like. In this description, the term “content provider” should be understood in a broad sense as a party capable of delivering content in any manner, either physically or electronically.

However, it is a problem that the user must detect or register the displayed information on a played media piece and either take a note or remember it until making the purchase. As a consequence, the user may refrain from this effort or simply forget about it, even though he/she would actually desire the played media piece, also resulting in missed revenue for content providers. A more convenient and reliable mechanism for purchasing media is therefore needed requiring a minimum of effort and attention from the user for making a purchase of streamed media.

Another problem is that the above-described solution requires the handling of two communication channels: one channel for the streamed media S and another one for the related metadata M. This is a drawback particularly for mobile terminals relying on scarce and therefore relatively expensive radio resources. It is thus further desirable to avoid the present use of a separate channel for metadata. Even if the terminal would be configured to “remember” the music piece by registering currently received metadata, a separate channel for transmitted metadata is still required, and a content provider must also be found that can deliver the wanted music piece.

### SUMMARY

The object of the present invention is to address at least some of the problems outlined above. In particular, it is an object to provide a solution which enables convenient purchase of streamed media, not requiring a separate channel for metadata. These objects and others can be achieved primarily by a solution according to the appended independent claims.

According to different aspects, a method and an arrangement are defined for purchasing streamed media when a communication terminal operated by a user receives a media stream containing various media objects as data packets from a streaming server. In a method executed in the communication terminal, if user input is received for the purchase of a currently played wanted media object, a purchase request is automatically sent to the streaming server in response to the user input. A download enabler is then received in response to the purchase request containing information leading to the wanted media object, and the wanted media object is downloaded based on the received download enabler.

An arrangement in the communication terminal comprises means for receiving user input for the purchase of a currently played wanted media object and means for sending a purchase request to the streaming server in response to the received user input. The arrangement further comprises means for receiving a download enabler in response to the sent purchase request containing information leading to the wanted media object, and means for downloading the wanted media object based on the received download enabler.

A time stamp or packet sequence may be determined in a data packet which has been received but not yet played and discarded, and the time stamp or packet sequence is then included in the purchase request. If RTP is used for streaming the media, the time stamp or packet sequence can be read from an RTP header in the data packet.

The received download enabler may be a download descriptor that can be used for obtaining the media object from a download server according to the OMA download standard. Alternatively, the received download enabler may be a URL pointing to a first download server from which a download descriptor can be obtained, in order to fetch the wanted media object from a second download server according to the OMA download standard.

According to further aspects, a method and an apparatus are also defined for supporting the purchase of streamed media when a streaming server transmits a media stream containing various media objects as data packets to a communication terminal operated by a user. In a method executed in the streaming server, a purchase request is received from the user terminal for a currently played wanted media object, the wanted media object is identified, and a corresponding download enabler is determined containing information leading to the wanted media object. The download enabler is then sent to the user terminal in response to the received purchase request.

An arrangement in the streaming server comprises means for receiving a purchase request from the user terminal for a currently played wanted media object, means for identifying the wanted media object and determining a corresponding download enabler containing information leading to the wanted media object, and means for sending the download enabler to the user terminal in response to the received purchase request.

The wanted media object may be identified based on a time stamp or packet sequence for a data packet in the transmitted media stream. The received purchase request may include said time stamp or packet sequence. Alternatively, the time stamp or packet sequence may be determined by the streaming server from a currently sent packet in the data stream. In that case, the media object may be identified as the one being played at the time of receiving the purchase request. A predetermined delay hysteresis may then be used by saving data packets a hysteresis time after being sent from a playout buffer. If RTP is used for streaming the media, the time stamp or packet sequence can be read from an RTP header in the data packet.

The download enabler may be a download descriptor that can be used for obtaining the media object from a download server according to the OMA download standard. Alternatively, the download enabler may be a URL pointing to a first download server from which a download descriptor can be obtained, in order to fetch the wanted media object from a second download server according to the OMA download standard.

Further features and benefits of the present invention will become apparent from the detailed description below.

### BRIEF DESCRIPTION OF THE DRAWINGS

The present invention will now be described in more detail by means of preferred embodiments and with reference to the accompanying drawings, in which:

FIG. 1 is a basic overview of a procedure of purchasing streamed media, according to the prior art.

FIG. 2 is a basic overview of a procedure and arrangement for purchasing streamed media, in accordance with one embodiment.

FIG. 3 is a flow chart illustrating a procedure in a user terminal for purchasing streamed media, in accordance with another embodiment.

FIG. 4 is a block diagram of a user terminal adapted to purchase streamed media, in accordance with yet another embodiment.

FIG. 5 is a flow chart illustrating a procedure in a media server for supporting the purchase of streamed media, in accordance with yet another embodiment.

FIG. 6 is a block diagram of a streaming server adapted to support the purchase of streamed media, in accordance with yet another embodiment.

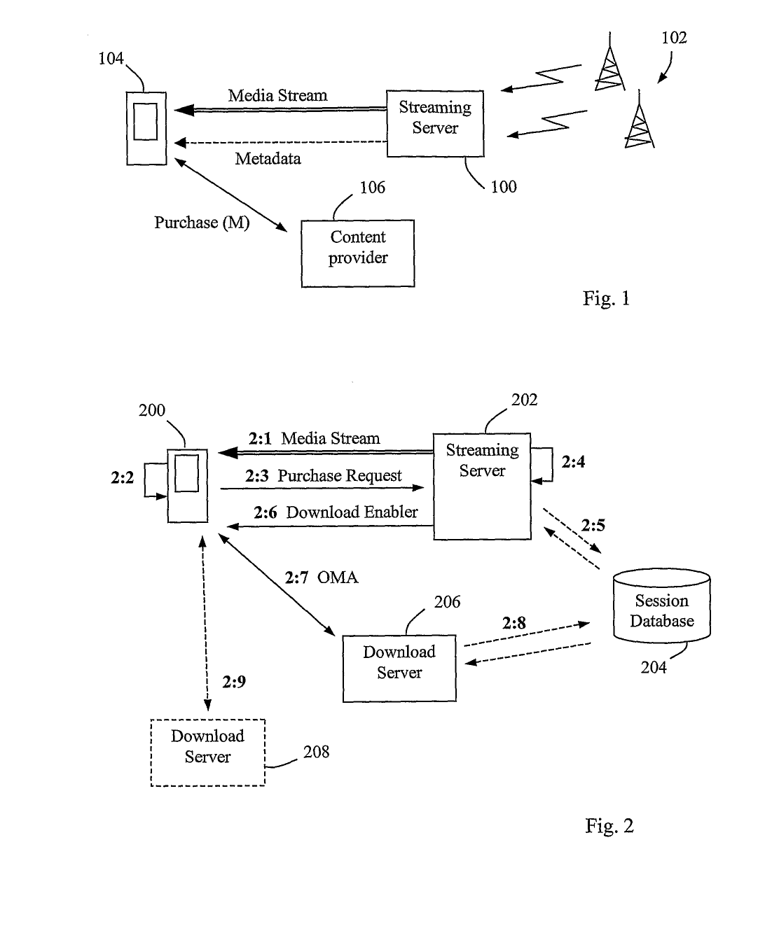

### DETAILED DESCRIPTION

Briefly described, the present invention provides a solution where a user, while listening to some media such as a song being streamed to his/her terminal from a streaming server, can initiate a purchase of a presently played media object simply by making an input command to the terminal. The terminal then automatically sends a purchase request to the streaming server, optionally containing timing information for the requested piece of media from which the streaming server can identify the requested media piece. In this solution, the purchase is thus effectuated automatically in a manner to be described below, and the user is basically not required to take any further actions. In this description, the term “media object” should be understood in a broad sense to represent any type of audio or video media, typically a piece of music or a film.

A procedure and arrangement for purchasing streamed media according to one embodiment will now be described with reference to FIG. 2. In a first illustrated step 2:1, a user terminal 200 receives a media stream of data packets from a streaming server 202 which is played out to a user, e.g. in accordance with the above-described conventional technique for media streaming. Typically, terminal 200 is a mobile terminal although the present invention is not limited thereto, and basically any type of fixed or wireless user terminal capable of receiving streamed media can be used in this context. A streaming client in the terminal is also typically used, including a packet buffer for playback.

If the user decides to purchase a currently played media object such as a song, he/she can make a suitable input command such as pushing a button or the like, implying: “buy the currently played media object”. In response thereto, the terminal 200 creates a purchase request, as indicated in a step 2:2, optionally containing timing information for the wanted media object which can be read in a recently received packet. The packet to be read for determining the timing information can be selected in different ways. For example, the latest received packet in the data stream may be read, or the next packet in the buffer to be played at the time of user input. Basically, any received data packet still residing in the terminal before being played and discarded may be selected for obtaining timing information, assuming that the time between reception and playback is short enough to ensure that the correct media object is addressed by the selected data packet.

The term “timing information” is intended to represent data basically indicating at what point the packet occurs in the data stream, from which the identity of the media object can be determined knowing the timing and/or sequence of media objects in the stream. The read timing information may be the above-described time stamp and/or packet sequence normally contained in the header of any RTP packets.

Next, terminal 200 sends the created purchase request to the streaming server 202 in a step 2:3, preferably including the read timing information described above. In response thereto, streaming server 202 can identify the requested media object by means of the received timing information. Alternatively, a purchase request for a wanted media object may be sent without the timing information. In that case, it is still possible for the streaming server 202 to determine the identity of the wanted media object as the one actually being played at the time of receiving the request. A predetermined delay hysteresis of a few seconds may then be used by saving data packets a hysteresis time after being sent from a playout buffer in the streaming server 202. Determining the identity of the wanted media object may be based on timing information in the currently sent packets in the data stream, or simply by knowing the timing of individual media objects occurring in the stream.

Using the received timing information or otherwise, streaming server 202 thus identifies the media object and retrieves a download enabler for the wanted media object, in a following step 2:4, basically containing information that the terminal can use for downloading the wanted media object. As will be appreciated from the following, the term “download enabler” is intended to represent any information leading to the wanted media object.

In a practical implementation, the download enabler may be a so-called download descriptor which is a small file containing metadata regarding a media object and instructions to a user terminal on how to download the media object, including a URL (Universal Resource Locator) pointing to the media object as stored in a download server. These instructions can be effectuated by a download agent in the terminal, according to conventional procedures. The download descriptor is previously known and defined in a standard called “OMA (Open Mobile Alliance) Download”.

It is assumed that the streaming server 202 maintains a database (not shown) containing metadata and associated timing information on media objects occurring in the media stream. Thereby, such metadata can be obtained for a media object requested at a specific point in time, e.g. by means of the timing information in a data packet, either received in the purchase request or derived by the streaming server.

Next, it may be necessary to retrieve a terminal identity MSISDN (Mobile Subscriber ISDN Number) from a session database 204 storing session information for the terminal, in an optional step 2:5. The session database 204 typically resides in the home service network of the user and generally stores MSISDN information associated with currently assigned IP addresses. Thus, if the purchase request in step 2:3 contains only a temporary IP address as the source address of the terminal 200, the MSISDN may be needed in order to respond.

The streaming server 202 is now able to send the relevant download enabler for the identified media object to the terminal 200, in a step 2:6, possibly using the retrieved MSISDN if step 2:5 was executed. In step 2:6, the download enabler may be sent to the terminal as a download descriptor in a WAP (Wireless Application Protocol) Push message, an SMS (Short Message Service), or any other suitable message. In practice, a WAP Push message is typically sent via a so-called “Push Proxy Gateway” and an associated SMS Centre.

Alternatively, the streaming server 202 may send a URL pointing to a download server from which the relevant download descriptor can be obtained, in order to fetch the wanted media object residing in another download server. The URL may likewise be sent in a WAP Push message, SMS, or the like.

If the download descriptor is received in step 2:6, the terminal can retrieve the wanted media object from a download server 206, using the download descriptor according to standard OMA procedures. Although these well-known procedures lie outside the scope of the present invention, the following further steps may be executed in order to complete the purchase, according to a possible implementation.

Thus, a download agent in the terminal may execute instructions contained in a received download descriptor indicating how to download the media object, according to the OMA download standard. The download descriptor includes a URL pointing to a download server 206 that can provide the media object. A next step 2:7 generally indicates that the terminal contacts the download server 206 and executes an OMA download session, involving standard messages not necessary to describe here in order to understand the present invention. Here, download server 206 may also need to retrieve the MSISDN from session database 204, in an optional step 2:8, in order to charge the user for the purchase, specifically if the terminal 200 uses the temporary IP address as the source address in the OMA procedure of step 2:3.

As mentioned above, the download enabler communicated in step 2:6 may alternatively be a message instructing the terminal to retrieve a download descriptor from a first download server 206 in order to download the media object from a second download server 208, as indicated by a final optional step 2:9. For example, the first download server 206 may belong to the home service network, and the second download server 208 holding the actual media object may belong to a third party accessed over the Internet.

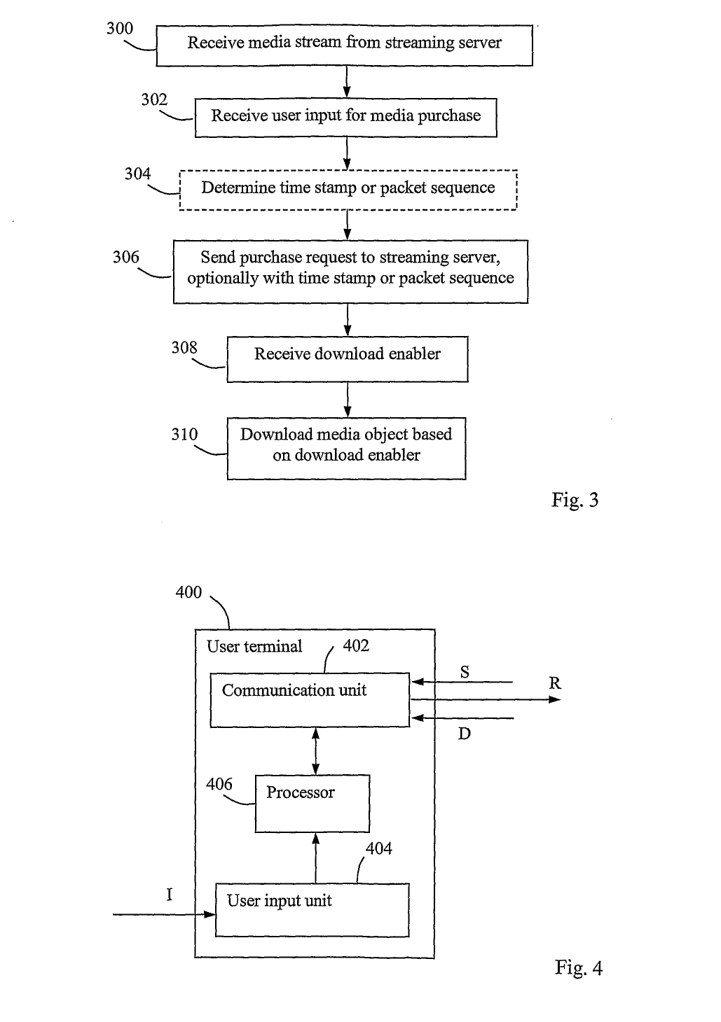

A procedure for purchasing streamed media in accordance with another embodiment will now be described, with reference to FIG. 3 illustrating a flow chart with steps executed in a communication terminal operated by a user. In a first step 300, a media stream containing various media objects is more or less continuously received as data packets from a streaming server. In a next step 302, some kind of user input is received for a media purchase, such as the user pushing a button or similar when wanting to buy the media object being currently played.

In an optional next step 304, a time stamp or packet sequence may be determined in a data packet which has been received but not yet played and discarded, in response to the received user input. The time stamp or packet sequence may be helpful for the streaming server to identify which media object the user wants to buy. However, the streaming server may identify the wanted media object otherwise as explained above, and step 304 can then be omitted in the process, depending on the implementation.

In a next step 306, a purchase request for the wanted media object is automatically sent to the streaming server, optionally including the time stamp or packet sequence if step 304 was executed. Then, a download enabler is received from the streaming server, in a following step 308, in response to the purchase request of step 306. As described above for the example of FIG. 2, the download enabler is preferably a download descriptor that can be used for obtaining the wanted media object according to the OMA download standard, but is not limited thereto. In a further step 310, the wanted media object is finally downloaded e.g. according to standard procedures, based on the received download enabler.

FIG. 4 illustrates a schematic block diagram of an arrangement in a user terminal 400 that can be used to purchase streamed media basically in accordance with the above-described process of FIG. 3. The user terminal 400 comprises a communication unit 402 adapted to receive a media stream S from a streaming server (not shown), and a user input unit 404 adapted to receive some kind of user input I for the purchase of a media object, such as a button or similar that the user can push when wanting to buy currently played media.

User terminal 400 further comprises a processor 406 adapted to create a purchase request R, in response to receiving the user input I at the user input unit 404. Processor 406 may be further adapted to determine and add to the purchase request R a time stamp or packet sequence in a received but not yet discarded data packet, which may be helpful for the streaming server to identify the wanted media object.

Communication unit 402 is then further adapted to send the created purchase request R to the streaming server, and to receive a download enabler D in response thereto, e.g. in a WAP Push message or the like. The received download enabler D can then be used for obtaining the wanted media object, e.g. according to conventional procedures. As mentioned above, the download enabler D may be a download descriptor in accordance with the OMA standard, or any other message that contains information that can be used for downloading the wanted media object.

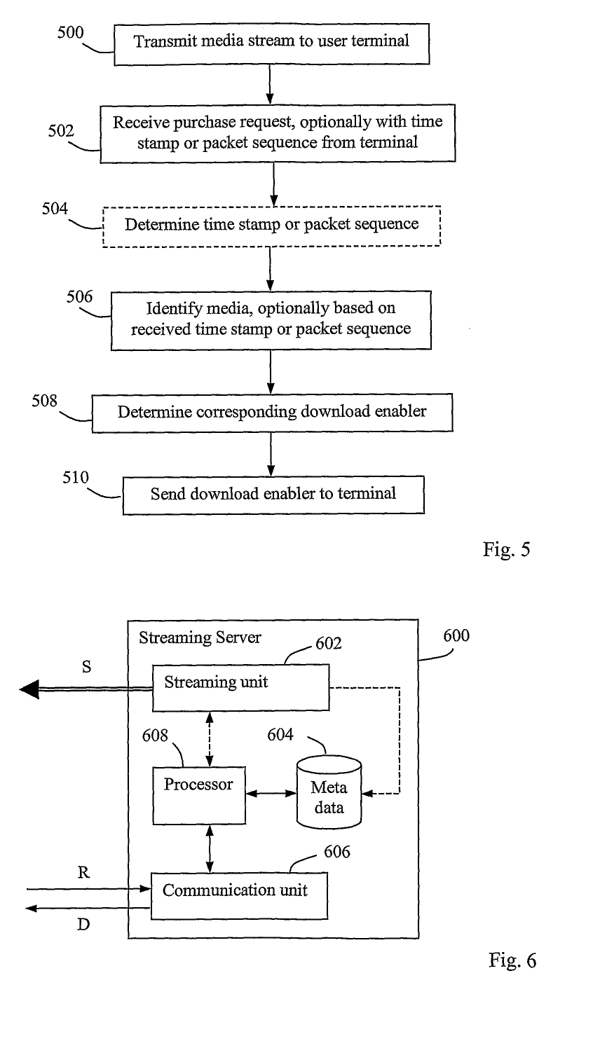

A procedure for supporting the purchase of streamed media in accordance with another embodiment will now be described, with reference to FIG. 5 illustrating a flow chart with steps executed in a streaming server. In a first step 500, a media stream containing various media objects is more or less continuously transmitted as data packets to a communication terminal operated by a user. In a next step 502, a purchase request for a media object is received from the user terminal, optionally including a time stamp or packet sequence.

If not included in the purchase request, the streaming server may then determine a relevant time stamp or packet sequence in an optional next step 504. The wanted media object is basically identified in a step 506, which may be done based on the time stamp or packet sequence, either received in step 502 or determined in step 504. In this step 506, the streaming server may determine the identity of the wanted media object as the one actually being played at the time of receiving the request in step 502, possibly using a predetermined delay hysteresis of a few seconds. This identity determination may also be based on timing information in the currently sent packets in the data stream, or simply by knowing the timing of individual media objects occurring in the stream.

A corresponding download enabler is then determined in a following step 508, e.g. as a download descriptor according to the OMA standard, or otherwise as described above. Finally, the determined download enabler is sent to the user terminal in a step 510, in response to the purchase request of step 502.

FIG. 6 illustrates a schematic block diagram of an arrangement in a streaming server 600 that can be used to support the purchase of streamed media basically in accordance with the above-described process of FIG. 5. Streaming server 600 comprises a conventional streaming unit 602 adapted to more or less continuously transmit a media stream S, containing various media objects, as data packets to a communication terminal (not shown) operated by a user.

Streaming server 600 further comprises a database 604 containing metadata and associated timing information on media objects occurring in the media stream. The metadata and associated timing information may be supplied from the streaming unit 602 to the database 604 during the streaming session, as indicated by a dashed arrow. A communication unit 606 in the streaming server 600 is adapted to receive a purchase request R for a media object from the user terminal, optionally including a time stamp or packet sequence.

Streaming server 600 further comprises a processor 608 adapted to identify the wanted media object and to determine a corresponding download enabler. The processor 608 may be adapted to identify the media object based on a time stamp or packet sequence, which may be included in the received purchase request R or determined by the streaming server 600 from a currently sent packet in the data stream. The media object may also be identified as the one actually being played at the time of receiving the request, possibly using a predetermined delay hysteresis of a few seconds, knowing the timing of individual media objects occurring in the stream.

The processor 608 may be further adapted to determine the download enabler by retrieving such metadata from the database 604 using associated timing information either given in the purchase request R or determined otherwise. As described above for the example of FIG. 2, the download enabler is preferably a download descriptor that can be used for obtaining the wanted media object according to standard OMA procedures, but is not limited thereto. The processor 608 may also be adapted to determine the download enabler directly from the time stamp or packet sequence. Communication unit 606 is further adapted to send the download enabler D to the user terminal in response to the purchase request.

By means of the present invention, a convenient and reliable mechanism for purchasing streamed media is obtained, requiring a minimum of effort and attention from the user for making such a purchase. Using the above-described solution, a separate communication channel with the user terminal for metadata related to streamed media can also be avoided. Moreover, it is not necessary to configure the user terminal with information on any download server or content provider from which media objects can be purchased, since this information is provided in the download enabler received from the streaming server.

While the invention has been described with reference to specific exemplary embodiments, the description is generally only intended to illustrate the inventive concept and should not be taken as limiting the scope of the invention, which is defined by the appended claims.

1. A method of purchasing streamed media as executed in a communication terminal operated by a user when receiving a media stream containing at least one media object as data packets from a streaming server, comprising the following steps:
receiving user input for the purchase of a currently played wanted media object,
sending a purchase request for the wanted media object to the streaming server in response to said user input,
receiving a download enabler in response to said purchase request containing information that the terminal can use for downloading the wanted media object, and
downloading the wanted media object based on the received download enabler.

2. The method according to claim 1, wherein a time stamp or packet sequence is determined in a data packet which has been received in the media stream but not yet played and discarded, and the time stamp or packet sequence is included in the purchase request.

3. The method according to claim 2, wherein RTP is used for streaming said media and said time stamp or packet sequence is read from an RTP header in the data packet.

4. The method according to claim 1, wherein the received download enabler is a download descriptor that can be used for obtaining said wanted media object from a download server according to the OMA download standard.

5. The method according to claim 1, wherein the received download enabler is a URL pointing to a first download server from which a download descriptor can be obtained, in order to fetch the wanted media object from a second download server according to the OMA download standard.

6. An arrangement in a communication terminal operated by a user, for purchasing streamed media when receiving a media stream containing at least one media object as data packets from a streaming server, comprising:
means for receiving user input for the purchase of a currently played wanted media object,
means for sending a purchase request for the wanted media object to the streaming server in response to said user input,
means for receiving a download enabler in response to said purchase request containing information that the terminal can use for downloading the wanted media object, and
means for downloading the wanted media object based on ‘the received download enabler.

7. The arrangement according to claim 6, further comprising means for determining a time stamp or packet sequence in a data packet which has been received in the media stream but not yet played and discarded, and means for including the time stamp or packet sequence in the purchase request.

8. The arrangement according to claim 7, wherein RTP is used for streaming said media and said time stamp or packet sequence is read from an RTP header in the data packet.

9. The arrangement according to claim 6, wherein the received download enabler is a download descriptor that can be used for obtaining said wanted media object from a download server according to the OMA download standard.

10. The arrangement according to claim 6, wherein the received download enabler is a URL pointing to a first download server from which a download descriptor can be obtained, in order to fetch the wanted media object from a second download server according to the OMA download standard.

11. A method of supporting the purchase of streamed media as executed in a streaming server when transmitting a media stream containing at least one media object as data packets to a communication terminal operated by a user, comprising the following steps:
receiving a purchase request from the user terminal for a currently played wanted media object,
identifying the wanted media object and determining a corresponding download enabler containing information that the terminal can use for downloading the wanted media object, and
sending the download enabler to the user terminal in response to said purchase request.

12. The method according to claim 11, wherein the wanted media object is identified based on a time stamp or packet sequence for a data packet in the transmitted media stream.

13. The method according to claim 12, wherein the received purchase request includes said time stamp or packet sequence.

14. The method according to claim 12, wherein said time stamp or packet sequence is determined by the streaming server from a currently sent packet in the data stream.

15. The method according to claim 12, wherein RTP is used for streaming said media and said time stamp or packet sequence is read from an RTP header in the data packet.

16. The method according to claim 11, wherein the wanted media object is identified as the one being played at the time of receiving the purchase request.

17. The method according to claim 16, wherein a predetermined delay hysteresis is used when identifying the wanted media object, by saving data packets a hysteresis time after being sent from a playout buffer.

18. The method according to claim 11, wherein said download enabler is a download descriptor that can be used for obtaining said media object from a download server according to the OMA download standard.

19. The method according to claim 11, wherein said download enabler is a URL pointing to a first download server from which a download descriptor can be obtained, in order to fetch the wanted media object from a second download server according to the OMA download standard.

20. An arrangement in a streaming server for supporting the purchase of streamed media when transmitting a media stream containing at least one media object as data packets to a communication terminal operated by a user, comprising the following steps:
means for receiving a purchase request from the user terminal for a currently played wanted media object,
means for identifying the wanted media object and determining a corresponding download enabler containing information that the terminal can use for downloading the wanted media object, and
means for sending the download enabler to the user terminal in response to said purchase request.

21. The arrangement according to claim 20, adapted to identify the wanted media object based on a time stamp or packet sequence for a data packet in the transmitted media stream.

22. The arrangement according to claim 21, wherein the received purchase request includes said time stamp or packet sequence.

23. The arrangement according to claim 21, adapted to determine said time stamp or packet sequence from a currently sent packet in the data stream.

24. The arrangement according to claim 21, wherein RTP is used for streaming said media and said time stamp or packet sequence has been read from an RTP header in the data packet.

25. The arrangement according to claim 20, adapted to identify the wanted media object as the one being played at the time of receiving the purchase request.

26. The arrangement according to claim 25, wherein a predetermined delay hysteresis is used when identifying the wanted media object, by saving data packets a hysteresis time after being sent from a playout buffer.

27. The arrangement according to claim 20, wherein said download enabler is a download descriptor that can be used for obtaining said wanted media object from a download server according to the OMA download standard.

28. The arrangement according to claim 20, wherein said download enabler is a URL pointing to a first download server from which a download descriptor can be obtained, in order to fetch the wanted media object from a second download server according to the OMA download standard.
